(19) United States
(12) Patent Application Publication
(10) Pub. No.: US 2024/0069780 A1
(43) Pub. Date: Feb. 29, 2024

(54) IN-MEMORY COMPUTING ARCHITECTURE FOR NEAREST NEIGHBOR SEARCH OF COSINE DISTANCE AND OPERATING METHOD THEREOF

(71) Applicant: ZHEJIANG UNIVERSITY, ZHEJIANG (CN)

(72) Inventors: Xunzhao YIN, ZHEJIANG (CN); Che-Kai Liu, ZHEJIANG (CN); Haobang Chen, ZHEJIANG (CN); Cheng ZHUO, ZHEJIANG (CN)

(73) Assignee: ZHEJIANG UNIVERSITY, ZHEJIANG (CN)

(21) Appl. No.: 18/080,654

(22) Filed: Dec. 13, 2022

(30) Foreign Application Priority Data
Aug. 25, 2022 (CN) 202211025181.4

(51) Int. Cl. G06F 3/06

(52) U.S. Cl. CPC G06F 3/065; G06F 3/0688; G06F 3/0604

(57) ABSTRACT

Disclosed are an in-memory computing architecture for a nearest neighbor search of a cosine distance and an operating method thereof. The in-memory computing architecture comprises two FeFET-based storage arrays, Translinear circuits and a WTA circuit, and the two storage arrays are a first storage array and a second storage array, respectively; wherein each of the storage cells comprises a FeFET and a resistor which are electrically connected; an input vector is inputted into the first storage array for outputting the inner product X of the input vector multiplied by all the storage vectors in the first storage array; the second storage array outputs the sum of squares Y of all vector elements in the storage vectors; the output values of the first storage array and the second storage array are respectively inputted into the Translinear circuits through current mirrors; and the Translinear circuits output X²/Y to the WTA circuit.

### CROSS-REFERENCE TO RELATED APPLICATION

This application claims the priority benefit of China application no. 202211025181.4. filed on Aug. 25, 2022. The entirety of each of the above mentioned patent applications is hereby incorporated by reference herein and made a part of this specification.

### FIELD OF TECHNOLOGY

The present invention relates to the field of storage, computation, and circuitry, and realizes an in-memory computing architecture for a nearest neighbor search of a cosine distance and an operating method thereof.

### BACKGROUND

In the artificial intelligence era, various binary neural networks (BNNs) and Hyperdimensional Computing (HDC) have proven to be efficiently applied to different actual scenarios such as object tracking, sound recognition, image clustering, etc. A cosine-based approximate search is widely studied at an algorithm level, and its operation is completed based on a current von Neumann computer architecture. However, limited to existing computer architectures, this operation results in a significant energy consumption and delay.

Although the design of various in-memory computing cells has been widely proposed in recent years, the problems of delay and energy consumption of the traditional von Neumann computer architecture are solved, and Hamming code calculation is implemented by utilizing an in-memory computing cell. However, the related work of the in-memory computing cell based on a cosine distance is still very scarce. At present, only a storage and calculation cell is utilized to implement approximate cosine similarity calculation of the HDC, and the related implementation is not applicable to a wider application such as a binary neural network.

Although the cosine approximate search has proven its value at an application level, adding the in-memory computing cell can break through negative effects such as the delay and energy consumption caused by the traditional von Neumann computer architecture, and the related implementations are still very rare.

### SUMMARY

An objective of the present invention is to provide an in-memory computing architecture for a nearest neighbor search of a cosine distance and an operating method thereof. of which energy consumption, delay, robustness, etc., compared with the prior art, are improved.

The present invention provides an in-memory computing architecture for a nearest neighbor search of a cosine distance, wherein the in-memory computing architecture comprises two FeFET-based storage arrays. Translinear circuits and a WTA circuit, and the two storage arrays are a first storage array and a second storage array, respectively;

each of the storage arrays comprises a plurality of storage rows. each of the plurality of storage rows is formed by connecting a plurality of storage cells in parallel, wherein each of the storage cell comprises a FeFET and a resistor which are electrically connected, and each storage row in the same storage array stores a different storage vector;

one storage row in one of the two storage arrays corresponds to one storage tow of another one of the two storage arrays, and the storage vectors stored in the two corresponding storage rows are the same;

an input vector is inputted into the first storage array, for outputting an inner product X of the input vector being multiplied by all the storage vectors in the first storage array;

the second storage array outputs the sum of squares Y of all vector elements in the storage vectors;

output values of the first storage array and the second storage array are respectively inputted into the Translinear circuits through current mirrors;

the Translinear circuits output X²/Y to the WTA circuit; and

the WTA circuit is used to select a maximum X²/Y value from all X²/Y corresponding to all of the storage rows, wherein a storage row corresponding to the maximum X²/Y value is a nearest neighbor of the cosine distance between the input vector and all the storage vectors.

Further, each of the storage arrays has M storage rows; each of the storage row has N storage cells;

the resistor in the storage cells is electrically connected to a drain of the FeFET;

all the resistors of each of the storage rows are connected by terminals opposite to the corresponding FeFET to form a row line WL of the storage row;

after sources of all the FeFETs of each of the storage rows are connected, the sources are directly grounded or grounded through a switch; and

gates of all the FeFETs of storage cells in each column of each the storage arrays are connected as a bit line BL corresponding to the input vector.

Further, the corresponding storage rows of the first storage array and the second storage array share a Translinear circuit;

output of each storage row of the first storage array is copied through the current mirror for at least two copies which are inputted into the Translinear circuit corresponding to the row;

output of each storage row of the second storage array is copied through the current mirror for one copy which is inputted into the Translinear circuit corresponding to the row.

Further, output of each of the Translinear circuits is copied through the current mirror for one copy which is inputted into the WTA circuit, each input of the WTA circuit corresponds to one output, the output corresponding to a maximum input value has a maximum value, and the output corresponding to the other input value has a minimum value.

Further, the input vector is a binary input vector, and the second storage array outputs the number of ‘1’ in the storage vectors.

Further, if the number of the vector elements is increased by N times, a resistance value of each resistor in each storage cell is correspondingly adjusted to be increased by N times.

Further, the resistor in each of the storage cell is of the order of million ohms.

The present invention further provides an operating method of the in-memory computing architecture as described above, wherein the operating method comprises:
step 1: performing a write operation on the FeFET in each storage cell;
step 2: at the beginning of search, setting the bit line BL corresponding to each column in the first storage array as a voltage value corresponding to each element of the input vector; outputting. by the word line WL corresponding to the storage row of the first storage array, a current Iₓ corresponding to the inner product X of the input vector and the storage vectors held by the storage row; and, outputting, by the word line WL corresponding to the storage row of the second storage array, a current I_{y} corresponding to the sum of the squares Y of all the vector elements held by the storage row; and, outputting, by the Translinear circuits, a current Iₓ²/I_{y} corresponding to X²/Y, so that a maximum current outputted by the WTA circuit corresponds to a maximum value of all input currents Iₓ²/I_{y} and the nearest neighbor search of the cosine distance is realized.

Further, the step 1 is specifically as follows: enabling the FeFET to store ‘1’ or ‘0’ by applying a different voltage pulse to the gate of the FeFET.

The beneficial effects of the present invention are as follows:
1) The present invention proposes for the first time the in-memory computing architecture for the non-approximate nearest neighbor search of the cosine distance and the operating method thereof on the mathematical expression of the cosine distance;
2) In the present invention, the search energy consumption and search delay are both reduced;
3) The present invention still has good robustness considering a FeFET error, a transistor error and a power supply error;
4) The present invention proposes to utilize the resistor of the 1FeFET1R to realize the expandable in-memory architecture;
5) The present invention proposes the use of O(N) type WTA circuit without the use of traditional “tree” type WTA, which greatly saves the delay and energy consumption.

### BRIEF DESCRIPTION OF THE DRAWINGS

FIG. 1 is a schematic diagram of an overall structure of an in-memory computing architecture;

FIG. 2 is a schematic diagram of a Translinear circuit structure used in the present invention;

FIG. 3 is a schematic diagram of an O(N) WTA circuit structure used in the present invention;

FIG. 4 is a flow chart of an operating method of the in-memory computing architecture;

FIG. 5 is a schematic diagram of simulation results of an optimal current range of the Translinear circuit for realizing X²/Y;

FIG. 6 is a schematic diagram of a NN search, that is, WTA output results, under random data;

FIG. 7 is a schematic diagram of energy consumption and delay simulation results of increasing a vector length;

FIG. 8 is a schematic diagram of energy consumption and delay simulation results of increasing the number of rows of the architecture when the vector length is 1024 bits;

FIG. 9 is an output schematic diagram of the present invention under 100 Monte Carlo simulations considering an error of an FeFET itself, 10% of the size of a transistor, 10% of a threshold voltage error, and 10% of a power supply error.

### DESCRIPTION OF THE EMBODIMENTS

The present invention is further described in detail in combination with the accompanying drawings and specific embodiments.

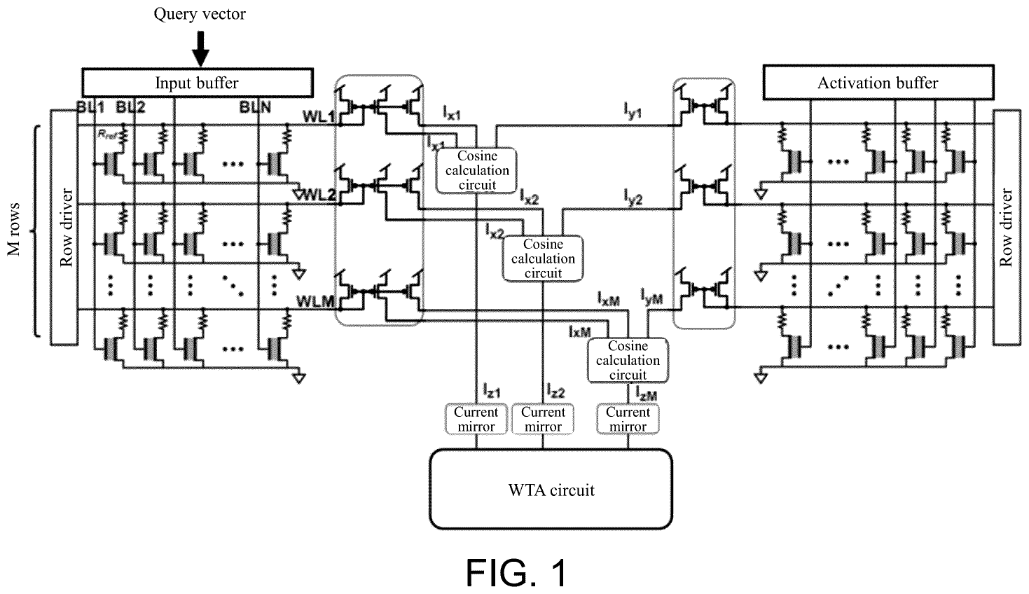

Please refer to FIG. 1, which shows an in-memory computing architecture for a nearest neighbor search of a cosine distance, wherein the in-memory computing architecture comprises two FeFET-based storage arrays. Translinear circuits and a (N) WTA circuit, and the two storage arrays are a first storage array and a second storage array, respectively; each of the storage arrays comprises a plurality of storage rows, each of the plurality of storage rows is formed by connecting a plurality of storage cells in parallel, wherein each of the storage cell comprises a FeFET and a resistor, the drain of each FeFET is connected to the resistor so as to form a 1FeFET1R structure, and each storage row in the same storage array stores a different storage vector. The feasibility of a 1FeFET1R cell in manufacturing has been given in a non-patent document 1 (Analog In-memory Computing in FeFET-based 1T1R Array for Edge AI Applications, Symposium on VLSI Technology, 2021).

The storage rows in the two storage arrays correspond to one another, and the storage vectors stored in the two corresponding storage rows are the same.

An input vector is inputted into the first storage array and the inner product X of the input vector and all the storage vectors is outputted; and the second storage array outputs the sum of squares Y of all vector elements in the storage vectors.

The output values of the first storage array and the second storage array are respectively inputted into the Translinear circuits through current mirrors; the Translinear circuits output X²/Y to the WTA circuit; and the WTA circuit is used to select a maximum value of X²/Y corresponding to all the storage rows, wherein a storage row corresponding to the maximum value of X²/Y is a nearest neighbor of the cosine distance between the input vector and all the storage vectors.

Next, the principle of the nearest neighbor search of the cosine distance using the Translinear circuits is explained, and the deduction thereof is as follows:
(1) A mathematical expression of cosine calculation is firstly squared, that is,

$${cos}^{2} θ = \frac{{( \vec{a} \cdot \vec{b} )}^{2}}{{( ‖ \vec{a} ‖ \cdot ‖ \vec{b} ‖ )}^{2}} ,$$

the Translinear X²/Y circuit is utilized to realize an operation of square division, that is, X represents (\vec{a}·\vec{b}), Y represents (∥\vec{a}∥·∥\vec{b}∥)².
(2) Since the value of a norm square of the input vector \vec{a}, ∥\vec{a}∥², is same for the cosine values between the input vector and all the storage vectors, and a cosine approximate search can ignore this value, that is, Y represents (∥\vec{b}∥)².

(3) By far, X² of the Translinear X²/Y circuit is namely (\vec{a}·\vec{b})², that is, the Translinear Iₓ input port is the inner product of the input vector and the storage vectors, and Y of the Translinear X²/Y circuit, that is, Translinear I_{y}, is ∥\vec{b}∥².

(4) Further, the mathematical meaning of ∥\vec{b}∥² is namely the number of ‘1’ in a binary vector.

(5) Further, in order to calculate the number of ‘1’ in the binary vector, all the BLs of different columns in the second storage array can be set to ‘1’.

In order to calculate the inner product between the input vector and the storage vectors, the 1FeFET1R storage cell is constructed in the present invention, the resistor in the storage cell is connected to the drain of the FeFET, the other terminals of the resistors in all the storage cells in each storage row are connected to form a vector, and at the same time, ‘1’ or ‘0’ is inputted into the gate of each FeFET in this vector, that is, the ‘AND’ operation can be carried out with the ‘1’ or ‘0’ stored in the FeFET. After the sources of all the FeFETs of all the storage cells in each of the storage rows are connected, the sources are directly grounded or grounded through a switch.

It can be deduced from (4) that the cosine expression is squared and then the denominator thereof is reduced to ∥\vec{b}∥², and the mathematical meaning of ∥\vec{b}∥² is the number of ‘1’ in the binary vector \vec{b}. In order to calculate the number of ‘1’ stored in the storage vector, another storage array is constructed.

The corresponding storage rows of the two storage arrays have a common Translinear circuit; the output of each storage row of the first storage array is copied through the current mirror for at least two copies which are inputted into the Translinear circuit corresponding to the row; and, the output of each storage row of the second storage array is copied through the current mirror for one copy which is inputted into the Translinear circuit corresponding to the row.

The output of each of the Translinear circuits is copied through the current mirror for one copy which is inputted into the WTA circuit, each input of the WTA circuit corresponds to one output, the output corresponding to a maximum input value has a maximum value, and the output corresponding to the other input value has a minimum value.

In addition, if the number of the vector elements is increased by N times, the resistance value of the resistor in each storage cell is adjusted to be increased by N times. Through the large resistance in the storage cell structure, the working current of the architecture is small, and then the architecture is robust.

The in-memory computing architecture of the present invention is further explained as follows:

1. The input of translinear circuits is calculated by two FeFET-based storage arrays

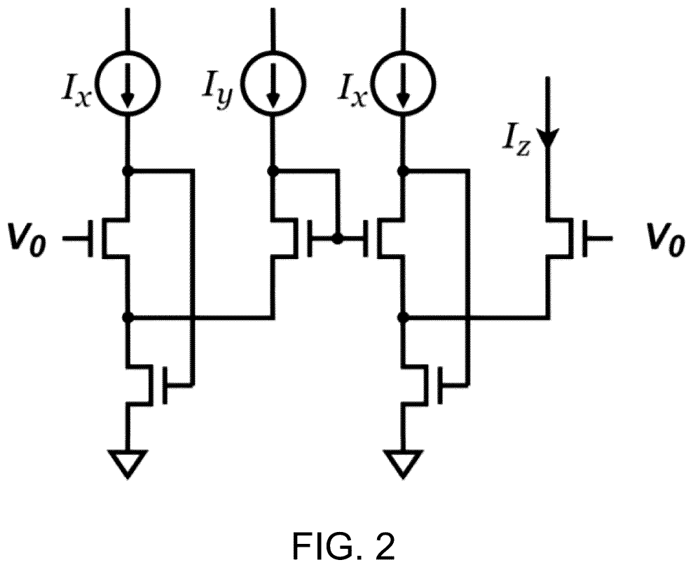

As shown in FIG. 1, one of the storage cells in the storage array is formed by connecting a resistor R_{ref} to the drain of the FeFET. Wherein, an N-dimensional vector consists of N storage cells connected through the other terminals of the resistors, and the total output current of any WL corresponds to a result of the inner product of its storage row vectors, which is copied by the current mirror and used as the input of two Iₓ of the Translinear circuit, as shown in FIG. 2. On the right side of FIG. 1, the second storage array can calculate the number of ‘1’ in each binary vector, which is specifically as follows:

In a search stage, its input, that is, each column of BL, is maintained at a high level, and the WL outputs a current I_{y} corresponding to the sum of the squares Y of all the vector elements in the storage vector stored in the corresponding storage row. The WL output current is copied through the current mirror and then used as the input of the Translinear circuit I_{y}, as shown in FIG. 2.

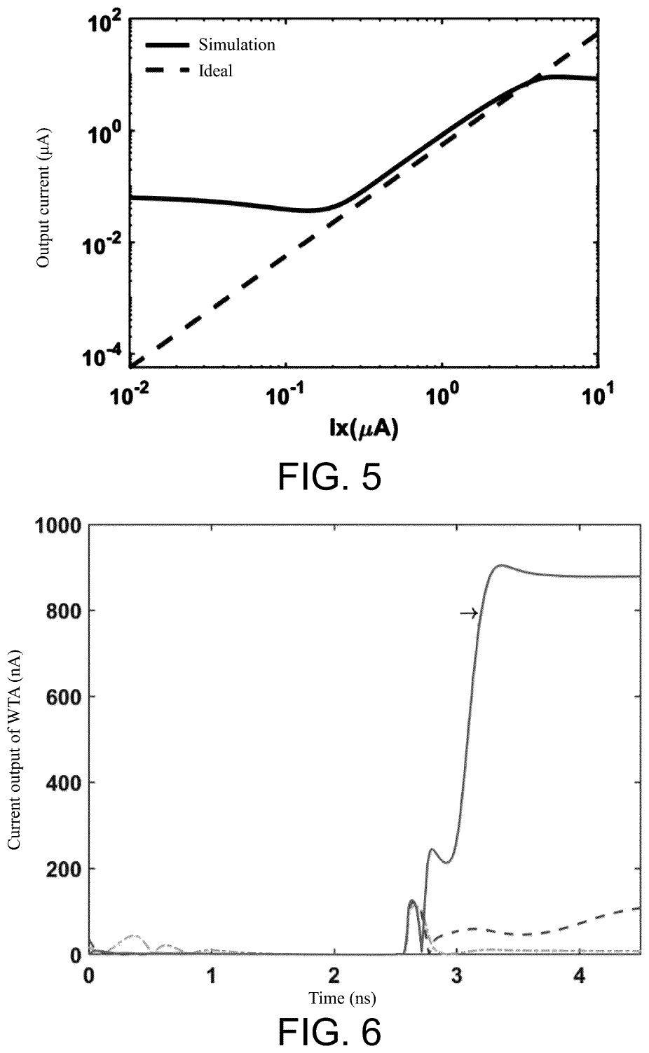

2. The circuit expressing square division in the translinear circuit is shown in FIG. 2, and an accurate operating current range is confirmed to be a nanoampere (nA) level, as shown in FIG. 5. Due to the limitation of the 1FeFET1R structure of the storage cell and the effective range of the Translinear circuit operation, the present invention further proposes that the vector length can be extended while the current magnitude level is unchanged by adjusting the resistance value of the resistor in the storage cell, namely:

$${I}_{z} = \frac{{( \frac{{I}_{x}}{n} \times n )}^{2}}{\frac{{I}_{y}}{n} \times n} = \frac{{I}_{x}^{2}}{{I}_{y}}$$

If the number of the vector elements of the storage vector and the input vector is increased by N times, the resistance value of the resistor in each storage cell is correspondingly adjusted to be increased by N times.

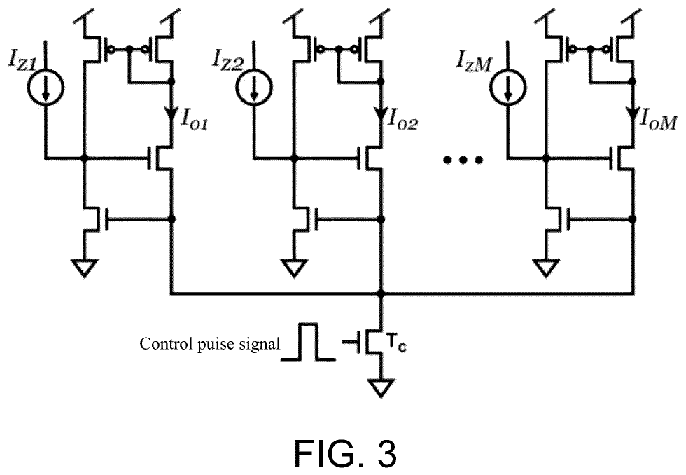

3. The Translinear circuit receives three input ports Ix, Iy and Ix, as shown in FIG. 2, and outputs I_{z}, and I₂=Iₓ²/I_{y}. As shown in FIG. 3, the I_{z} output corresponding to each storage row is copied through the current mirror so as to input the WTA circuit, the maximum current outputted by the WTA circuit corresponds to the maximum value of all the input currents Iₓ²/I_{y}, wherein the output corresponding to the inputted maximum current has the maximum current, and the output corresponding to the inputted other values has the minimum current, as shown in FIG. 6, which realizes the nearest neighbor search of the cosine distance.

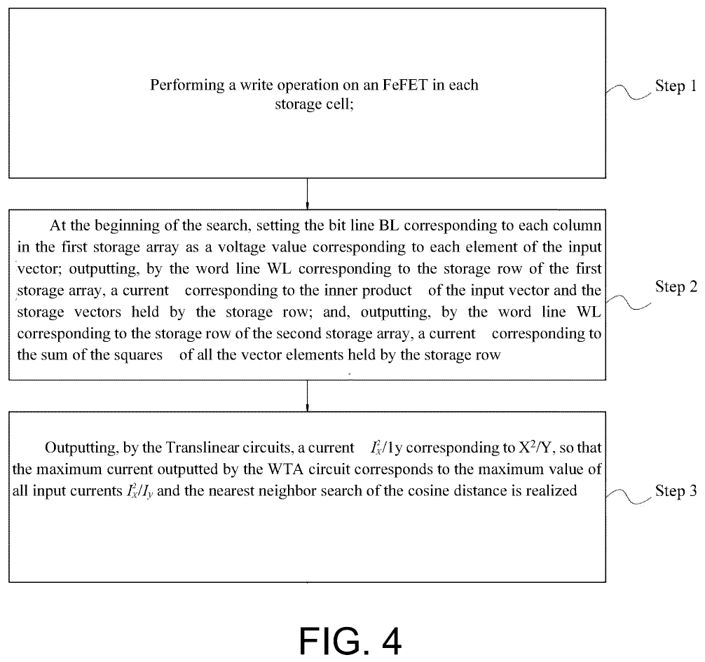

Please refer to FIG. 4, the present invention also provides an operating method of the in-memory computing architecture as described above, wherein the method comprises:

step 1: writing the FeFET in each storage cell, which is specifically as follows: enabling the FeFET to store ‘1’ or ‘0’ by applying a different voltage pulse to the gate of the FeFET.

Specifically, before the search starts, binary vector elements are written respectively for the two storage arrays through the BL consisting of the grids of each column of FeFETs; and writing ‘0’ with a −4V voltage pulse and ‘1’ with a +4V voltage pulse. After the vector elements are written to the two storage arrays, the search process begins.

step 2: at the beginning of the search, setting the bit line BL corresponding to each column in the first storage array as a voltage value corresponding to each element of the input vector; outputting, by the word line WL corresponding to the storage row of the first storage array, a current Iₓ corresponding to the inner product X of the input vector and the storage vectors held by the storage row; and, outputting, by the word line WL corresponding to the storage row of the second storage array, a current I_{y} corresponding to the sum of the squares Y of all the vector elements held by the storage row.

Specifically, during the search, the vector elements of the search vector are written through the BL consisting of the grids of each column of FeFETs, with 1V representing ‘1’ and 0V representing ‘0’. For implementing the inner product function by the FeFETs, the description is as follows:

If ‘1’ is inputted and the value stored in the FeFET cell is ‘1’, a large current is outputted; and for the other three cases, that is, ‘1’ is inputted and ‘0’ is stored, ‘0’ is inputted and ‘1’ is stored, ‘0’ is inputted and ‘0’ is stored, a small current is always outputted, thereby realizing the operation of the inner product (\vec{a}·\vec{b}) of the vectors. For a storage array for computing the number of ‘1’ in the vector, its column input, that is, the BL always remain ‘1’ at the time of search. Since ‘1’ “AND” ‘0’ is zero, ‘1’ “AND” ‘1’ is one, the number of ‘1’ in the vector is calculated.

step 3: outputting. by the Translinear circuits, a current Iₓ²/I_{y} corresponding to X²/Y. so that the maximum current outputted by the WTA circuit corresponds to the maximum value of all input currents Iₓ²/I_{y} and the nearest neighbor search of the cosine distance is realized.

Specifically, the maximum current output of the WTA circuit inputted by I_{z} which is outputted by the Translinear circuits corresponds to the maximum input port; and, when the output of the WTA circuit can be distinguished, the search ends and the current source below the WTA circuit is turned off, that is, the gate of Tc in FIG. 3 is set to ‘0’. By far, the in-memory cosine NN search is completed.

The functions and effects of the present invention are further illustrated and demonstrated by the following simulation experiment:

1. Simulation Conditions

A SPECTRE and SPICE compatible model based on a physical circuit is used to simulate the in-memory computing architecture for the nearest neighbor search of the cosine distance which consists of the storage arrays consists of 1FeFET1R storage cells, the Translinear circuits and the WTA circuit, wherein the FeFET is based on a Preisach model. This model achieves a efficient design and analysis, and has been widely used in FeFET circuit design. PTM45-HP is used as a simulation model for other PMOS and NMOS transistors.

2. Simulation Results

(1) NN Search Results

FIG. 6 shows the results of NN search, that is, the WTA output, in the case of a random input. that is, the presence of neighbor and the cosine value being zero. The maximum output current is the vector with the largest cosine value between the corresponding storage vector and the input vector, and the other waveforms are the results of the nearest neighbor search current of which the cosine values between the corresponding storage vectors and the input vector are from the second to the largest to the smallest.

(2) FIG. 5 shows an optimal range of the Translinear circuit operation of the square division. This result is obtained by fixing I_{y} at 600 nA (corresponding to a mean internal product current result) and scanning Iₓ from 1 nA to 10 μA. The simulation results show that the square division Translinear circuit based on the PTM45-HP has upper and lower limits for the input current.

(3) Energy Consumption and Delay

Compared with the approximate cosine search for HDC proposed in a non-patent document 2 (G. Karunaratne et al., “Robust high-dimensional memory-augmented neural networks.” Nature Communications, vol. 2, April 2021.), the present invention obtains 90.5 times reduction in energy consumption per cell and a 333 times reduction in output delay.

(4) Consumed Area

Compared with a non-patent reference 3 (M. Imani et al., “Exploring hyperdimensional associative memory.” in HPCA. IEEE, 2017, pp. 445-456.), the area consumption of the present invention is significantly reduced, which is mainly because for the NN search, the present invention utilizes the 1FeFET1R structure, based on a non-patent literature 4 (T. Soliman et al.,

“Ultra-lowpower flexible precision fefet based analog in-memory computing.” in IEDM, 2020.), the output current deviation of the FeFET is greatly reduced, so it is not necessary to use the ‘tree’ type WTA (Winner-Take-All)/LTA (Loner-Take-All) structure for the NN search, and then the number of the transistors is greatly reduced.

(5) Scalability

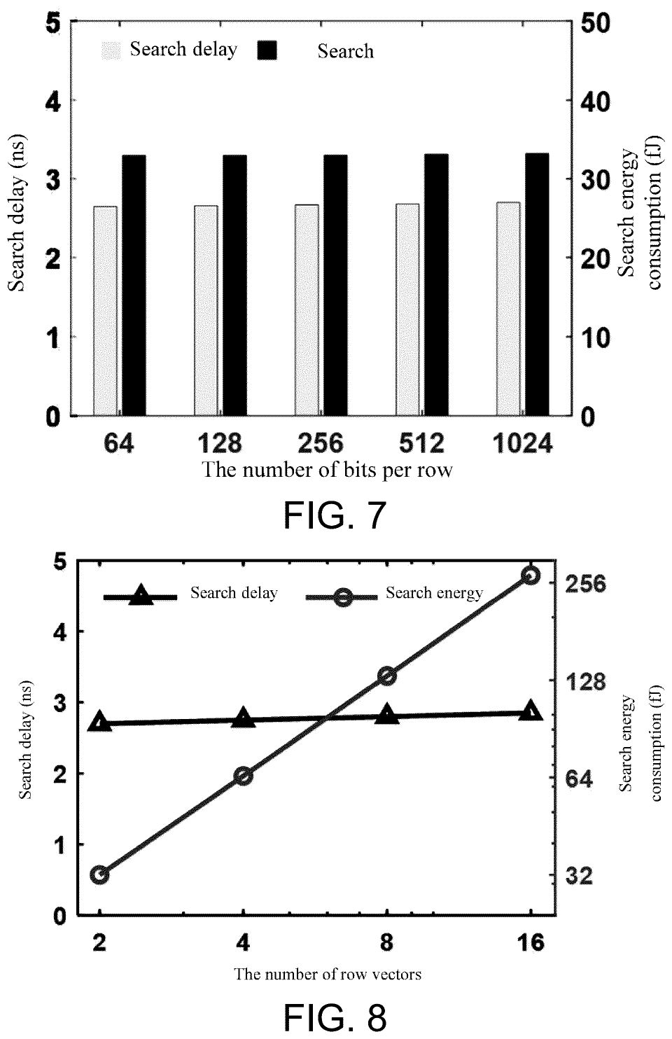

FIG. 7 shows that when extending the vector length from 64 bits per vector to 1024 bits per vector, the energy consumption and delay of the present invention almost have no impact, because of adjusting the resistance values of the resistors in the storage cells. FIG. 8 shows the simulation results of the energy consumption and delay when the vector length is 1024 bits and the number of rows of the architecture is increased. For the extended number of rows, the energy consumption increases linearly, while the delay is not affected, proving the extensibility of the WTA. It is shown that the present invention is feasible for the cosine approximate search of the HDC.

(6) Robustness

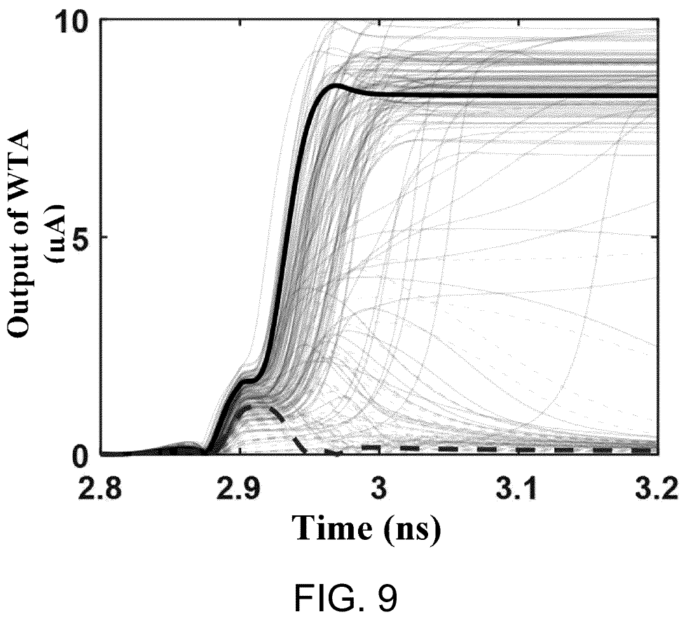

FIG. 9 is intended to illustrate the robustness of the present invention. Under 100 Monte Carlo simulations considering the errors of the FeFET, transistor and power supply, the present invention can still maintain the error results within 10%, because the output deviation of the FeFET is greatly reduced by utilizing the 1FeFET1R structure. Moreover, the error of 10% is within the acceptable range for the HDC, see the non-patent documents 2 and 3.

The above embodiments are used to explain the present invention, but not to limit it, and any modification or alteration of the present invention within the spirit and protection scopes of the claims of the present invention falls within the protection scopes of the present invention.

What is claimed is:

1. An in-memory computing architecture for a nearest neighbor search of a cosine distance, wherein the in-memory computing architecture comprises two FeFET-based storage arrays, Translinear circuits and a WTA circuit, and the two storage arrays are a first storage array and a second storage array, respectively;
each of the storage arrays comprises a plurality of storage rows, each of the plurality of storage rows is formed by connecting a plurality of storage cells in parallel, wherein each of the storage cell comprises a FeFET and a resistor which are electrically connected, and each storage row in the same storage array stores a different storage vector;
one storage row in one of the two storage arrays corresponds to one storage row of another one of the two storage arrays, and the storage vectors stored in the two corresponding storage rows are the same;
an input vector is inputted into the first storage array, for outputting an inner product X of the input vector being multiplied by all the storage vectors in the first storage array;
the second storage array outputs the sum of squares Y of all vector elements in the storage vectors;
output values of the first storage array and the second storage array are respectively inputted into the Translinear circuits through current mirrors;
the Translinear circuits output X²/Y to the WTA circuit; and
the WTA circuit is used to select a maximum X²/Y value from all X²/Y corresponding to all the storage rows, wherein a storage row corresponding to the maximum X²/Y value is a nearest neighbor of the cosine distance between the input vector and all the storage vectors.

2. The in-memory computing architecture of claim 1, wherein each of the storage arrays has M storage rows; each of the storage row has N storage cells;
the resistor in the storage cell is electrically connected to a drain of the FeFET;
all the resistors of each of the storage rows are connected by terminals opposite to the corresponding FeFET to form a row line WL of the storage row;
after sources of all the FeFETs of each of the storage rows are connected, the sources are directly grounded or grounded through a switch; and
gates of all the FeFETs of storage cells in each column of each of the storage arrays are connected as a bit line BL corresponding to the input vector.

3. The in-memory computing architecture of claim 1, wherein the corresponding storage rows of the first storage array and the second storage array share a Translinear circuit;
output of each storage row of the first storage array is copied through the current mirror for at least two copies which are inputted into the Translinear circuit corresponding to the row;
output of each storage row of the second storage array is copied through the current mirror for one copy which is inputted into the Translinear circuit corresponding to the row.

4. The in-memory computing architecture of claim 1, wherein output of each of the Translinear circuits is copied through the current mirror for one copy which is inputted into the WTA circuit, each input of the WTA circuit corresponds to one output, the output corresponding to a maximum input value has a maximum value, and the output corresponding to the other input values has a minimum value.

5. The in-memory computing architecture of claim 1, wherein the input vector is a binary input vector, and the second storage array outputs the number of ‘1’ in the storage vectors.

6. The in-memory computing architecture of claim 1, wherein if the number of the vector elements is increased by N times, a resistance value of each resistor in each storage cell is correspondingly adjusted to be increased by N times.

7. The in-memory computing architecture of claim 1, wherein the resistance in each of the storage cell is of the order of million ohms.

8. An operating method for the in-memory computing architecture of claim 1, wherein the operating method comprises:
step 1: performing a write operation on the FeFET in each storage cell;
step 2: at the beginning of search, setting the bit line BL corresponding to each column in the first storage array as a voltage value corresponding to each element of the input vector; outputting, by the word line WL corresponding to the storage row of the first storage array, a current Iₓ corresponding to the inner product X of the input vector and the storage vectors held by the storage row; and, outputting, by the word line WL corresponding to the storage row of the second storage array, a current I_{y} corresponding to the sum of the squares Y of all the vector elements held by the storage row; and,
step 3: outputting, by the Translinear circuits, a current Iₓ²/I_{y} corresponding to X²/Y, so that a maximum current outputted by the WTA circuit corresponds to a maximum value of all input currents Iₓ²/I_{y} and the nearest neighbor search of the cosine distance is realized.

9. The operating method of claim 8, wherein the step 1 is specifically as follows: enabling the FeFET to store ‘1’ or ‘0’ by applying a different voltage pulse to the gate of the FeFET.
